(19) United States
(12) Patent Application Publication
(10) Pub. No.: US 2002/0113826 A1
(43) Pub. Date: Aug. 22, 2002

(54) System and method for simultaneously displaying weather data and monitored device data

(76) Inventor: Paul Chuang, Clarksburg, MD (US)

Correspondence Address: Hughes Electronics Corporation, Patent Docket Administration, P.O. Box 956, Bldg. 1, Mail Stop A109, El Segundo, CA, 90245-0956, US

(21) Appl. No.: 09/789,985

(22) Filed: Feb. 21, 2001

(51) Int. Cl. G06F 3/00

(52) U.S. Cl. 345/835; 345/839

(57) ABSTRACT

The present invention provides a monitoring station within a telecommunication system having a plurality of substations, wherein a user may monitor a single screen having the weather data superimposed onto substation map data. More particularly, each substation provides respective status data to the monitoring station. The status data and pre-existing map data are combined and used to create an image of the map of a predetermined area. Weather data is then retrieved in order to generate an image of precipitation corresponding to the map of the predetermined area. After acquiring both the map data, including the status data of each substation, and the weather data, a composite image is created by superimposing the map data and the weather data. The composite image is then displayed on a single display for the user to view.

### FIELD OF THE INVENTION

This invention relates generally to monitoring the operating performance of communication systems. More specifically, the present invention relates to the simultaneous monitoring of a plurality of network elements forming a telecommunication system, which are distributed over a wide geographical area.

### BACKGROUND OF THE INVENTION

One type of such a telecommunication system is a conventional satellite system which includes a multibeam antenna system that is deployed aboard each satellite in a constellation of orbiting satellites. Such a multibeam antenna system allows the satellites to transmit and receive signals, thereby allowing for communication between a plurality of portable, mobile and fixed terminals and gateways. A plurality of multibeam antennas is deployed on each satellite. Each one of the multibeam antennas simultaneously receives and transmits a plurality of beams, each of which is designed so as to have a specific shape, often referred to as a footprint. Each footprint of the multibeam antenna illuminates a specific geographical portion of the entire area covered by the system (e.g. the entire United States). Accordingly, the plurality of beams, each covering a specific geographic location, operate to form a grid, referred to as an “Earth-fixed” grid. The beams are focused on the segment of the Earth-fixed grid by a dielectric lens. Each beam may be electronically shaped and steered to keep the desired segment of the Earth-fixed grid within the footprint of the beam.

It is noted that while the state of the prior art and the various embodiments of the present invention set forth below utilize satellite systems as the exemplary telecommunication system for explaining the present invention, the present invention is in no way limited to such satellite based systems. As explained in detail below, the present invention can be utilized in any telecommunication system having a plurality of network elements disposed at geographical locations which are different from one another.

A conventional satellite communication system as described above is illustrated in FIG. 6. As seen in FIG. 6, satellite 602, in orbit around the earth receives data signals from and uplink station 604. Satellite 602 acts as a transponder, or repeater, which then retransmits the data signals from uplink station 604 down to downlink, or receiving, substations 606. Typically, at least one substation 608 of the substations 606, is a monitoring substation. Monitoring substation 608 typically monitors the status of a plurality the substations within satellite communication system. A user, manning the monitoring substation, is responsible for taking steps to rectify any problems associated with any one of the plurality of substations that are being monitored in the event that a negative status is detected at any given substation (e.g., the detected signal at the station as attenuated below an acceptable threshold).

One type of signal degradation problem facing satellite communication systems, such as described above, is caused by various weather conditions. For example, rain, or other precipitation, can cause downlink signal attenuation of as much as 20 dB (the higher the rain rate, the greater the degradation of the signal from the satellite to a ground recipient). Such extreme attenuation, or “precipitation fade,” can dramatically degrade recipient signal detection and therefore system availability and capacity. In some places, particularly places with generally equatorial climates, prolonged heavy rains can cause unacceptably prolonged attenuation of satellite downlink communications. More particularly, precipitation fade attenuation is caused principally by scattering and absorption of the transmitted signal by water droplets, thereby causing a reduction in the signal to noise ratio of the transmitted signal.

Because precipitation fade causes a reduction in signal-to-noise ratio (S/N), which must exceed a minimum threshold to allow consistent reception of the transmitted signal, some mechanism is usually provided to adjust one of several variables in the satellite link power budget in order to compensate for the decrease in signal to noise ratio. Among these variables are antenna gain, receiver noise temperature, coding rate and transmit power. For example, if it is determined that a particular downlink substation lies within an area of weather comprising a large amount of precipitation, the signal power of the retransmitted signal from the satellite may be increased in order to compensate for resulting signal degradation. As such, meteorological information corresponding to respective local areas within each monitored station may be essential.

Luckily, the field of meteorology has seen significant technological advances in the past ten years. New and innovative devices such as infrared satellites, wind and temperature profilers, thunderstorm detectors, all-sky cameras, Doppler radars and LIDAR have all helped meteorologists better understand and track precipitation. Further, in the mid 1970's, “color-radar” was introduced, which differentiates areas of precipitation using a color-coding scheme. Patches of heavy rain, snow or hail are all depicted the same way: in red. Lighter areas of precipitation are represented in shades of blue or green.

Conventional weathercasting systems may display dynamic real time pictorial representations of weather conditions created from meteorological data combined with geographical data. Geographical data is retrieved, digitized, and processed to produce an image and is stored in memory for later retrieval. Meteorological data including precipitation, cloud cover data, the bottom and top of cloud formations, and reflectivity and velocity of rain droplets in real-time are acquired from C-band and/or K-band Doppler radar, or non-Doppler K-band and Doppler X-band radar installations which ameliorate S-band radar data and the data is digitized and processed to produce a simulated image of the meteorological data. The meteorological data is then combined with the geographical data to produce a digital signal capable of being transmitted to a computer, displayed on a computer display screen, and manipulated by peripheral devices connected with the computer.

A conventional weathercast, for example from the weather portion of a television news broadcast, may use the above described display system. Specifically, the system uses a superimposed satellite display of fluffy cloud patterns shown moving along over a flat map from an exaggerated height observation point. The “blue screen” display behind the announcer still usually shows the familiar patchwork rainfall amounts in red, green and blue.

The above-described monitoring substations need direct access to the weather information, as opposed to merely viewing a processed version from a television weather forecast. To meet this need, the National Weather Service has a network of advanced S-Band Doppler radar stations in place within the United States, and is capable of delivering different products to several private weather service companies which act as intermediaries between the National Weather Service and the public. The monitoring systems may use the commercially available weather radar signal to automatically increase or decrease signal transmission strength to respective substations as needed.

As for the monitoring substation itself, it may include a video monitor for displaying a geographic map of a predetermined area, wherein all the substations to be monitored are depicted as icons. The user deployed at such monitoring substations may be responsible for dispatching diagnostic and/or maintenance orders to determine the origin and/or correct any problems associated with substations that are indicated as not being fully operational. For example, when a particular substation is receiving an attenuated signal as a result of precipitation fade, the user may instruct the satellite that is transmitting the signal to increase its transmission gain. Further, a user deployed at such monitoring stations may be responsible for informing substations that are receiving an attenuated signal as to why the received signal is attenuated, if it will be rectified, and when will it be rectified.

A problem with the above-identified monitoring substation is that the operator is unable to determine, or even rule out, possible causes of an attenuated signal or non-responsive substation. Therefore, by blindly increasing the gain of the transmitted signal without checking alternate possible problems, discovery of the true origin of the problem may be delayed. More importantly, correction of the problem may be delayed.

Still other monitoring systems further include an automatic response system. With such a system, if a particular substation is receiving an attenuated signal, the satellite sending the signal is automatically instructed to increase its transmission gain irregardless of whether a user notices the malfunction. These types of automatically correcting systems have the same problems of their non-automatic brethren. Specifically, blindly increasing the gain of the transmitted signal without checking alternate possible problems, may delay discovery and correction of the actual cause of the problem.

In an attempt to correct the problems of the above-identified monitoring systems, some monitoring substations include a second video monitor for displaying weather data. As stated above, this commercially available data may include the map of the predetermined area that the monitoring system monitors in addition to color-radar, which differentiates areas of precipitation using a color-coding scheme. For example, patches of heavy rain, snow or hail may be depicted the same way: in red, whereas lighter areas of precipitation may be represented in shades of blue or green. As opposed to the single monitor counterparts, the user deployed at these dual monitor substations may be able to compare the attenuated status of a substation on the first monitor with the corresponding weather data on the second monitor and determine whether the received signal is attenuated as a result of precipitation fade. More precisely, the user deployed at these dual monitor stations may be able to compare the attenuated status of a substation on the first monitor with the corresponding weather data on the second monitor and determine that the attenuated signal is not being caused by precipitation fade because there is no precipitation corresponding to that particular substation.

The problem with the above identified dual monitor substation is that the user must view two separate video screens and be able to perceptively superimpose the weather data onto the substation map data. This promotes inaccuracy when the user attempts to discern one cell from another on a first screen and the weather data on the second screen. This problem is further complicated due to the multitude of substations likely to be contained in the system.

Accordingly, there remains a need for a system that allows a user to readily, and accurately, discern how weather patterns are effecting operation of the substations. Moreover, the system must allow the user to determine how the weather is effecting the substation on a station-by-station basis, quickly and accurately.

### SUMMARY OF THE INVENTION

It is an object of the invention to provide a system that allows a user to readily, and accurately, discern how weather patterns are effecting operation of the substations/network element. It is a further object of the invention to provide a system that permits the user to determine how the weather is effecting the substation on a station-by-station basis, quickly and accurately. It is noted that the terms substations and network elements are intended to be utilized interchangeably in the given specification. The term substation is generally utilized in conjunction with systems employing satellites, while network element is generally utilized in systems not employing satellites. In both instances, the term is intended to refer to the monitoring/operating stations located at various geographical locations.

More specifically, the present invention provides a monitoring substation/network element (hereinafter referred to as a substation) wherein a user may monitor a single screen having the weather data superimposed onto substation map data. More particularly, each substation provides respective status data to the monitoring station. This status data may be provided over a network, or over dedicated communication lines. The status data may include a variety of parameters, non-limiting examples of which include i.e., no signal received, attenuated signal received, fully operational, etc. Further, this status data may be updated periodically, including real-time updates of changes to any substation status.

Once the status data is acquired, it is combined with pre-existing map data and stored persistently in a database. The database can be on the application server or anywhere in the local area network (LAN). The combined status data and pre-existing map data are used to create image data, wherein the image data may be used to create an image on a display of the map of a predetermined area. Within this map are icons representing corresponding substations and their respective locations. Further, the icons representing corresponding substations may differ in size, shape, color, or action (i.e., dynamically moving) to symbolize a different operational status or to operate as an alarm to indicate malfunctions. Specifically, each icon may contain information relating to the location of the substation it represents. Such a location may be, for example, its logical position (i.e., x, y, or its geographical position, namely, latitude, longitude). Each icon can also be utilized to indicate alarm severity (e.g., red for critical alarms, yellow for minor alarms). If there are multiple alarms for a given substation, the system can be programmed to depict the most critical alarm. In addition, icons can also be utilized to indicate the status of a substation (e.g., a wrench in the icon indicates a maintenance state, a red cross indicates “out of service”).

Once the image data is created and stored in the memory, weather data is retrieved in order to generate an image of precipitation corresponding to the map of the predetermined area. This weather data may be retrieved in various ways, such as through a network as provided by C-band and/or K-band Doppler radar, or non-Doppler K-band and Doppler X-band radar installations which ameliorate S-band radar data. The weather data is then digitized and processed to produce a simulated image of the meteorological data.

After acquiring both the map data, including the status data of each substation, and the weather data, a composite image is created by superimposing the map data and the weather data. The composite image is then displayed on a single display for the user to view.

A first embodiment of the invention provides a monitoring system for remotely monitoring the status of a device within a predetermined area and the amount of precipitation within the predetermined area, the system comprising a device to be monitored, and a monitoring station (e.g., an operation and maintenance center), the station being remote from the device and operable to receive status data corresponding to the device, the monitoring station comprising, a first memory (i.e., main thread) having image data stored therein, the image data including map data corresponding to a map of the predetermined area, and device data corresponding to the device, a data input for inputting data, a second memory (i.e., second thread) in communication with the data input, the second memory storing weather data input from a map server (i.e., input source), a processor/server for processing the image data and the weather data to create a composite image corresponding to weather data superimposed on the map data, and a display for displaying the composite image. Such an operation and maintenance center, if utilized as the monitoring station, can include LAN devices such as routers, application servers, databases, monitors, workstations, etc.

In another embodiment, the map data further includes data for creating indications of cell boundaries that subdivide the predetermined area into a plurality of cells.

In another embodiment, the map data further includes data for creating an icon corresponding to the status of the device.

In yet another embodiment, the system further includes a plurality of devices, wherein the map data further includes data for creating icons corresponding to the number and status of each respective device.

In still another embodiment, the system further includes a conversion module for converting a third type of data into the weather data.

In still yet another embodiment, updated weather data is periodically received at the input port and the second memory is correspondingly periodically updated.

In a further embodiment, the server is operable to process the image data and the weather data to create a second composite image corresponding to a magnified portion of the composite image.

In still a further embodiment, the monitoring stations are coupled together such that the weather data may be utilized by each the monitoring station.

The present invention also provides a method of remotely monitoring the status of a device within a predetermined area and the amount of precipitation within the predetermined area. The method comprises the steps of retrieving image data from a first memory (i.e., a first thread), the image data including map data corresponding to a map of the predetermined area, and device data corresponding to the device, retrieving weather data from a second memory (i.e., a second thread), processing, with a processor/server, the image data and the weather data to create a composite image corresponding to weather data superimposed on the map data, and displaying, with a display device, the composite image.

In another embodiment, the method of the present invention further includes the step of converting a third type of data into the weather data prior to the step of retrieving the weather data.

In still another embodiment, the method of the present invention further includes the step of providing indicators in the map data for subdividing the map into a composition of a plurality of cells, and altering an attribute of any cell, having a device disposed therein, when the device data indicates that the device is not receiving a signal or that the device is receiving an unacceptably attenuated signal.

It is also noted that the present invention is not limited to use with telecommunication systems employing satellites. The system can be utilized with any telecommunication system having numerous network elements positioned at various geographical locations.

An advantage of the present invention over that of prior art systems is that a user may quickly and easily determine if weather is a factor in a malfunctioning substation.

Another advantage of the present invention over that of prior art systems is that a user may anticipate upcoming weather problems and make necessary adjustments in advance. Further the user may warn anyone relying on particular substations of potential upcoming signal loss due to weather.

Yet another advantage of the present invention over that of prior art systems is that a user may determine if weather is a factor in malfunctioning substations on a cell-by-cell basis.

Additional advantages of the present invention will become apparent, to those skilled in the art, from the following detailed description of exemplary embodiments of the present invention. The invention itself, together with further objects and advantages, can be better understood by reference to the following detailed description and the accompanying drawings.

### BRIEF DESCRIPTION OF THE DRAWINGS

The accompanying drawings, which are incorporated in and form a part of the specification, illustrate embodiments of the present invention and, together with the description, serve to explain the principles of the invention. In the drawings:

FIG. 1 depicts an exemplary computer system that can be used to implement the present invention.

FIG. 2 illustrates a logic flow diagram of the operation of an exemplary system in accordance with the present invention.

FIG. 3 is a block diagram representing the use of a data conversion module in accordance with one embodiment of the present invention.

FIG. 4 is an exemplary image created with the map data and the weather data.

FIG. 5 is an exploded view of a portion of the map of the area to be monitored by the user.

FIG. 6 illustrates a conventional satellite communication system.

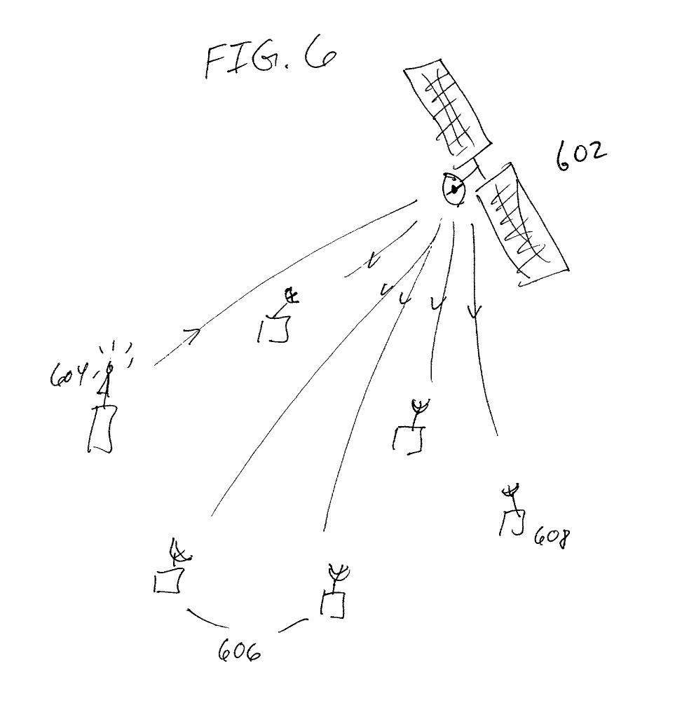

### DETAILED DESCRIPTION OF THE INVENTION

In the following description, for the purposes of explanation, numerous specific details are set forth in order to provide a more thorough understanding of the present invention. It will be apparent, however, to one skilled in the art that the present invention may be practiced without these specific details.

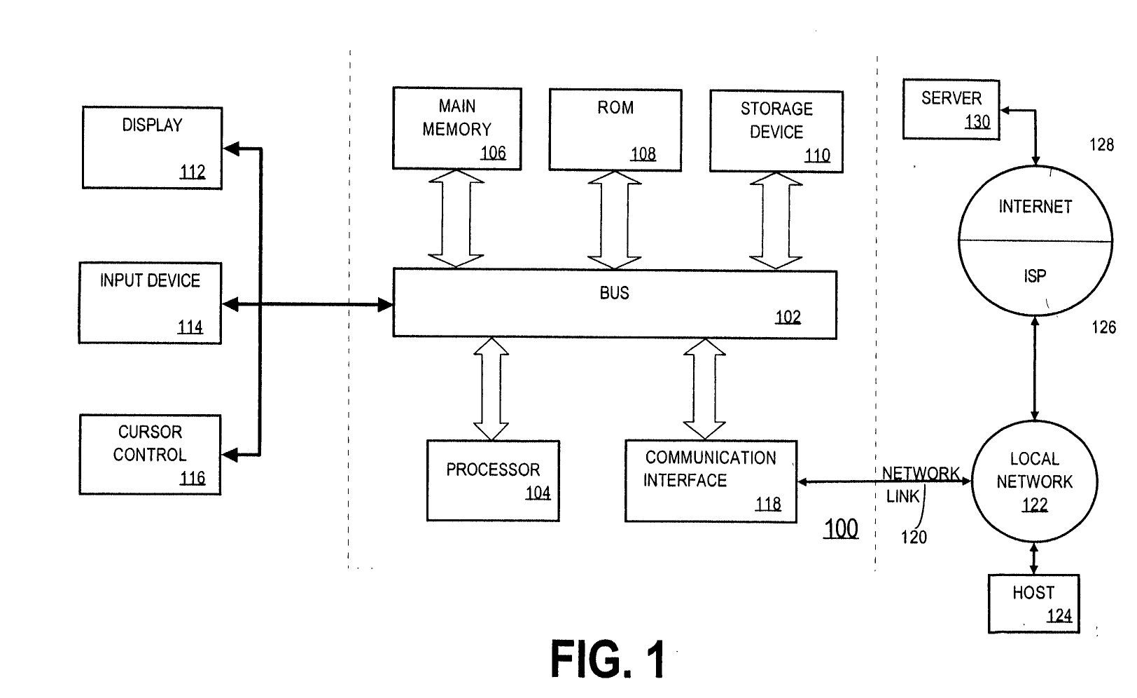

FIG. 1 is a block diagram that illustrates an exemplary computer system 100 for implementing the invention. The computer system 100 may be employed with any of the substations within the satellite communication system. Computer system 100 includes a bus 102 or other communication mechanism for transferring information data, and processor 104 coupled with bus 102 operative for processing information. Computer system 100 also includes a main memory 106, such as a random access memory (RAM) or other dynamic storage device, coupled to bus 102 for storing information and instructions to be executed by processor 104. Main memory 106 can store an image data file representing the map data in addition to the status data of each substation. Main memory 106 also can be used for storing temporary variables or other intermediate information during execution of instructions to be executed by processor 104 and processor 105. More specifically, main memory 106 may include an updateable data file representing the map data in addition to updateable status data of each substation. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y ), that allows the device to specify positions in a plane.

The term “computer-readable medium” used herein refers to any medium that participates in providing instructions to processor 104 for execution. Such a medium may take many forms, including but not limited to, nonvolatile media, volatile media, and transmission media. Non-volatile media include, for example, optical or magnetic disks, such as storage device 110. Volatile media include dynamic memory, such as main memory 106. Transmission media include coaxial cables, copper wire and fiber optics, including the wires that comprise bus 102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave, or any other medium from which a computer can read.

Various forms of computer readable media may be involved in carrying one or more sequences of one or more instructions to processor 104 for execution. For example, the instructions may initially be stored on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 and/or processor 105 retrieves and executes the instructions. The instructions received by main memory 106 may optionally be stored on storage device 110 either before or after execution by processor 104 and/or processor 105.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 1

and receives electrical, electromagnetic or optical signals that carry digital data streams representing various types of information. More specifically, communication interface 118 enables the monitoring substation to receive status data from each substation. Furthermore, communication interface 118 enables the monitoring substation to receive weather data from a data provider, such as described above.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the worldwide packet data communication network, now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120, and communication interface 118. In the Internet example, a server 130 might transmit a requested code for an application program through Internet 128, ISP 126, local network 122 and communication interface 118. In accordance with the invention, one such downloaded application provides for memory management in a run-time environment as described herein. Processor 104 may execute the received code as it is received via interface 118, and/or retrieved from storage device 110, or other non-volatile storage. In this manner, computer system 100 may obtain application code in the form of a carrier wave.

“Virtual memory” refers to memory addressable by a storage allocation technique in which auxiliary storage, such as memory in storage device 110, can be addressed as though it were part of the main memory 106. More specifically, combinations of hardware, firmware, and operating system cooperate to automatically swap portions of the code and data for an executing process on an as-needed basis. Thus, the virtual address space may be regarded as addressable main memory to a process executing on a computer system that maps virtual addresses into real addresses. The size of the virtual address space is usually limited by the size of a native machine pointer, but not by the actual number of storage elements in main memory 110. Specifically, storage device 110 provides a buffer memory for storing preprocessed weather data from the weather data provider. Once this data is stored, and if the data is not in a format compatible with the map data, the weather data may then be preprocessed in a conversion module within the processor 104. Further discussion of the weather data processing will follow.

In many operating systems, a process will utilize a certain amount of virtual memory that no other user process may access in order to provide data security. “Shared memory” refers to the virtual address space on the computer system 110 that is concurrently accessible to a plurality of executing user processes on a processor 104. In some embodiments, shared memory is also accessible to executing user processes on a plurality of processors.

“Secondary storage” used herein refers to storage elements, other than virtual memory, accessible to a process. Secondary storage may be local or networked. Local secondary storage, furnished by storage device 100 on computer system 100, is preferably a random access storage device such as a magnetic or optical disk. Networked secondary storage is provided by storage devices on other computer systems, for example on host 124, accessible over a local area network 122, or server 130, accessible over a wide area network such as the Internet.

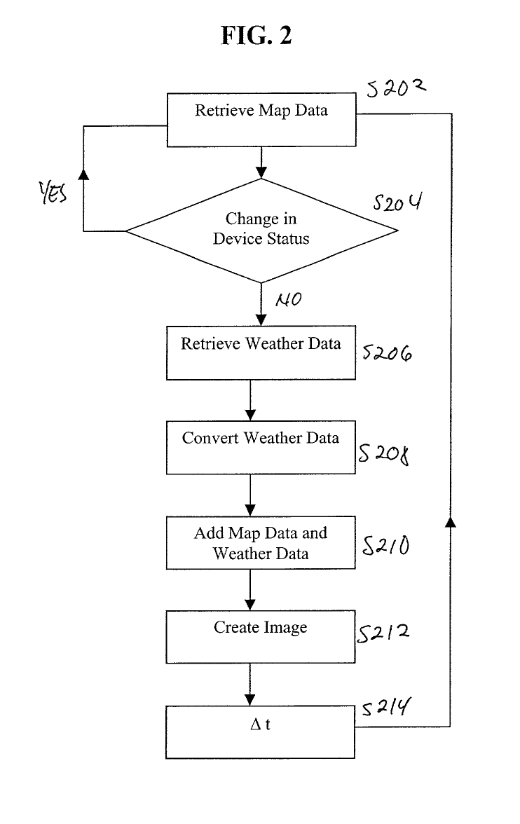

FIG. 2 illustrates a logic flow diagram of the operation of an exemplary system in accordance with the present invention.

In step S202, a first type of data corresponding to the device map is retrieved. This map data may include a pre-existing file stored in the either main memory 106 or the external storage device 110, or alternatively downloaded from another external source through the network link 120. This first type of data includes image data representing a map of a predetermined area, which a user is to visually monitor, for example a map of the continental United States. This map data may further include data for creating indications of cell boundaries, which subdivide the predetermined area into a plurality of cells. The map data may still further include data for creating icons, operative as visual indicators of the number and status of devices, which are to be monitored within each cell.

In an exemplary embodiment of the present invention, the devices that are to be monitored include satellite up-link and downlink stations. However, as stated above the present invention is not intended to be limited to a satellite based system. The present invention can be utilized with any telecommunication system having a plurality of network elements (i.e., substation) geographically dispersed, where it is necessary to quickly and easily determine how the weather is affecting the network elements. The visual indicators may be icons that visually represent the status of the devices that are to be monitored. Non-limiting examples of differentiating the status of devices with icons include changing any one, or combination, of size, shape, color, or animation of each icon. In one exemplary embodiment a visual indicator may indicate that a particular device is not functioning by: increasing the size of the icon representing the device; changing the shape of the icon representing the device; altering the color icon representing the device; and/or animating the icon representing the device, such making the icon blink.

In step S204, an inquiry is made as to whether the status of any device has changed since the map data was retrieved. Changes in device status may be stored in a separate file in the main memory 106, after being reported from the respective devices from Internet 128. If there are changes in the status of any devices, the pre-existing map data file may be updated accordingly, S202.

If there are no changes in the status of any devices, then in step S206, a second type of data corresponding to weather information is retrieved. This weather data may include a pre-existing file stored in the either main memory 106 or the external storage device 110, or alternatively downloaded from another external source through the network link 120. In an exemplary embodiment, weather data is downloaded via Internet 128 from any one of several private weather service companies described above.

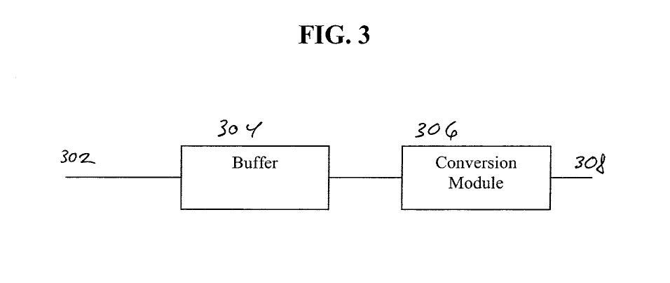

In step S208, if needed, the weather data is converted. More specifically, if the structure of the data file of the weather information is not entirely compatible with the map data, a data conversion module may be provided. FIG. 3 is a block diagram representing the use of a data conversion module in accordance with one embodiment of the present invention. The weather data 302 is downloaded into buffer 304, which is then sent to a conversion module 306. Buffer 304 may be the storage device 110 or a specific portion of the main memory 106. Conversion module may be custom built program running on processor 104 that converts the data structures of the downloaded data into data structures that are compatible with map data structures.

Once the conversion module converts the data structures, the converted weather data 308 is processed in the processor 104 with the map data, S210, so as to form complete image data, which represents a combination of the map data and weather data. Once the composite image data is generated, in step S212, the composite image data is sent to display 112 for viewing by the user.

Data that is collected and processed in order to render weather data requires tremendous computing power. As such, the current state of the art does not permit real-time weather data processing to the extent needed to render a useful image. Therefore, until computing power permits real-time weather data processing to the extent needed to render a useful image, the weather data is constantly updated at predetermined intervals. In as much, if needed in the present invention, after a predetermined period of time, S214, updated data corresponding to weather information is retrieved, S206, and the imaging process is repeated.

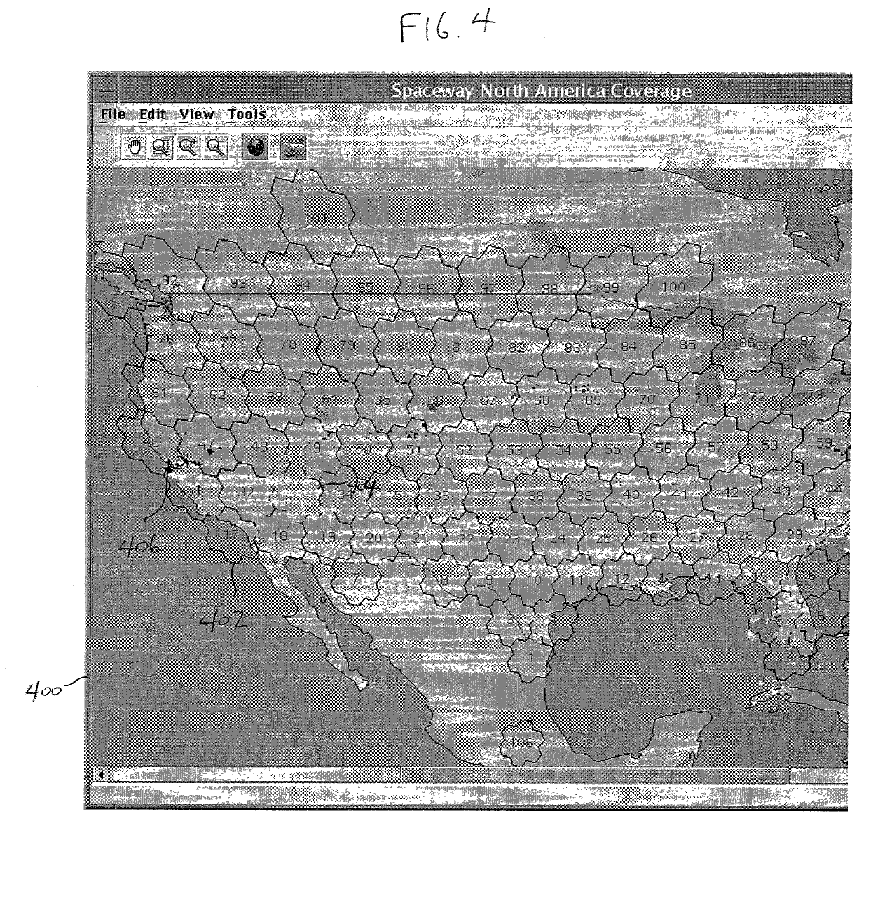

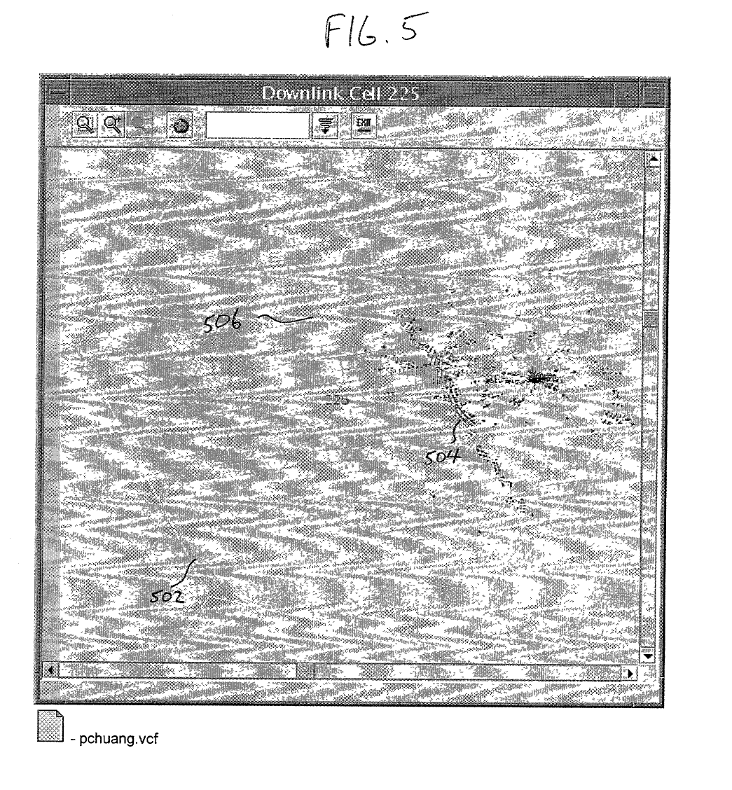

FIG. 4 is an exemplary image created with the map data and the weather data. As seen in FIG. 4, 400 is a map of an area to be monitored by the user. Within the map, a plurality of cells 402 include a plurality of icons 406 representing devices such as downlink and up-link stations. Each icon 406 visually represents to the user, the current status of the device, for example fully operational or malfunctioning, or not responding. More importantly, weather data (e.g., precipitation) 404 is superimposed upon the map. FIG. 5 is an exploded view of a portion of the map of the area to be monitored by the user. As seen in FIG. 5, a cell 502 includes a plurality of icons 504 in addition to weather data 506, which in this case represents precipitation.

As such, if an icon or plurality of icons visually represent that the respective devices are either malfunctioning or not responding, and the superimposed weather data indicates that the devices lie within a large amount of precipitation, such may be an indication to the user that the respective devices are malfunctioning or are not responding as a result of the precipitation.

In an exemplary embodiment, when a predetermined number of substations within a cell are not functioning properly (i.e. their respective reported status indicated that they are receiving an attenuated signal, etc.) and the superimposed weather data is of a predetermined type (i.e., precipitation) and/or amount, then the image of the entire cell may change. For example, if an icon of a substation within a cell indicates that the substation is not receiving a signal, or that the signal is attenuated below a predetermined threshold, and weather over that cell indicates a large amount of precipitation, that cell may change so that the user may easily recognize and associate the change in status with weather. Non-limiting examples of cell changes include changing the color and or dynamically changing the size or shape of the cell, i.e., giving the cell motion.

In another exemplary embodiment the system may include an automated system wherein, while visually informing a user that certain substations are not receiving a signal, or are receiving an unacceptably attenuated signal, with predetermined types and amounts of weather within the vicinity of the substations, procedures within the communication system are taken such that the transmitting satellite increases the power of the transmit signal to compensate.

Therefore, as described above, the system of the present invention allows a user to immediately, and easily, determine if a malfunction of a given substation is due to weather conditions. Specifically, by having a single image that includes the area to be monitored, the cells within the area, the devices within the cells, and super-imposed weather, a user may monitor the status of devices and weather with a single display. More specifically, as described above, a user may visually determine, with a single display, when weather is not a cause of malfunction or non-response for a device or plurality of devices. Further, a user may anticipate upcoming weather problems and make necessary adjustments in advance, or warn anyone relying on particular substations of potential upcoming signal loss due to weather. Still further, a user may determine if weather is a factor in malfunctioning substations on a cell-by-cell basis.

Although certain specific embodiments of the present invention have been disclosed, it is noted that the present invention may be embodied in other forms without departing from the spirit or essential characteristics thereof. The present embodiments are therefor to be considered in all respects as illustrative and not restrictive, the scope of the invention being indicated by the appended claims, and all changes that come within the meaning and range of equivalency of the claims are therefore intended to be embraced therein.

What is claimed is:

1. A monitoring station for remotely monitoring the status of a device within a predetermined area and the amount of precipitation within said predetermined area, said station being operable to receive status data corresponding to a device, said monitoring station comprising:
a first memory having image data stored therein, said image data including map data corresponding to a map of said predetermined area, and device data corresponding to said device;
a data input port for receiving data;
a second memory coupled to said data input port, said second memory storing weather data input from said data input port;
a processor for processing said image data and said weather data to create a composite image corresponding to weather data superimposed on said map data; and
a display for displaying said composite image.

2. The monitoring station of claim 1 wherein, said map data further includes data for creating indications of cell boundaries that subdivide the predetermined area into a plurality of cells.

3. The monitoring station of claim 1 wherein, said map data further includes data for creating an icon corresponding to the status of said device.

4. The monitoring station of claim 1, further including a plurality of devices, wherein said map data further includes data for creating icons corresponding to the number and status of each respective device.

5. The monitoring station of claim 1, further including a conversion module for converting a third type of data into said weather data.

6. The monitoring station of claim 1, wherein updated weather data is periodically received at said input port and said second memory is correspondingly periodically updated.

7. The monitoring station of claim 1, wherein said processor is operable to process said image data and said weather data to create a second composite image corresponding to a magnified portion of said composite image.

8. The monitoring station of claim 1, wherein said monitoring stations are coupled together such that said weather data may be utilized by each said monitoring station.

9. A method of remotely monitoring the status of a device within a predetermined area and the amount of precipitation within said predetermined area, said method comprising the steps of:
retrieving image data from a first memory, said image data including map data corresponding to a map of said predetermined area, and device data corresponding to said device;
retrieving weather data from a second memory;
processing, with a processor, said image data and said weather data to create a composite image corresponding to weather data superimposed on said map data; and
displaying, with a display device, said composite image.

10. The method of claim 9 wherein, said map data further includes data for creating indications of cell boundaries that subdivide the predetermined area into a plurality of cells.

11. The method of claim 9 wherein, said map data further includes data for creating an icon corresponding to the status of said device.

12. The method of claim 9, further including a plurality of devices, wherein said map data further includes data for creating icons corresponding to the number and status of each respective device.

13. The method of claim 9, further including the step of converting a third type of data into said weather data prior to the step of retrieving said weather data.

14. The method of claim 9, further including the steps of;
providing indicators in the map data for subdividing said map into a composition of a plurality of cells; and
altering an attribute of any cell, having a device disposed therein, when said device data indicates that said device is not receiving a signal or that said device is receiving an unacceptably attenuated signal.

15. A display system comprising:
a first memory having image data stored therein, said image data including map data corresponding to a map of a predetermined area, and device data corresponding to a device;
a data input port for receiving data;
a second memory coupled to said data input port, said second memory storing weather data input from said data input port;
a processor for processing said image data and said weather data to create a composite image corresponding to weather data superimposed on said map data; and
a display for displaying said composite image.

16. The display system of claim 15 wherein, said map data further includes data for creating indications of cell boundaries that subdivide the predetermined area into a plurality of cells.

17. The display system of claim 15 wherein, said map data further includes data for creating an icon corresponding to the status of said device.

18. The display system of claim 15, further including a plurality of devices, wherein said map data further includes data for creating icons corresponding to the number and status of each respective device.

19. The display system of claim 15, further including a conversion module for converting a third type of data into said weather data.

20. The display system of claim 15, wherein updated weather data is periodically received at said input port and said second memory is correspondingly periodically updated.

21. The display system of claim 15, wherein said processor is operable to process said image data and said weather data to create a second composite image corresponding to a magnified portion of said composite image.

22. The display system of claim 15, wherein said processor is operable to process said image data and said weather data to create a second composite image corresponding to a magnified portion of said composite image.

23. A method of displaying data comprising the steps of:
retrieving image data from a first memory, said image data including map data corresponding to a map of a predetermined area, and device data corresponding to a device;
retrieving weather data from a second memory;
processing, with a processor, said image data and said weather data to create a composite image corresponding to weather data superimposed on said map data; and
displaying, with a display device, said composite image.

24. The method of claim 23 wherein, said map data further includes data for creating indications of cell boundaries that subdivide the predetermined area into a plurality of cells.

25. The method of claim 23 wherein, said map data further includes data for creating an icon corresponding to the status of said device.

26. The method of claim 23, further including a plurality of devices, wherein said map data further includes data for creating icons corresponding to the number and status of each respective device.

27. The method of claim 23, further including the step of converting a third type of data into said weather data prior to the step of retrieving said weather data.
